(19) United States
(12) Patent Application Publication
(10) Pub. No.: US 2025/0322599 A1
(43) Pub. Date: Oct. 16, 2025

(54) Native Artificial Reality System Execution Using Synthetic Input

(71) Applicant: Meta Platforms Technologies, LLC, Menlo Park, CA (US)

(72) Inventors: Andrew Kog Wah CHANG, Los Angeles, CA (US); Spencer MILLER, Los Angeles, CA (US); Andrew ROSSETTER, Oviedo, FL (US); Ethan WELBORN, Liberty Hill, TX (US)

(21) Appl. No.: 19/032,910

(22) Filed: Jan. 21, 2025

Related U.S. Application Data
(60) Provisional application No. 63/556,129, filed on Feb. 21, 2024.

(51) Int. Cl. G06T 17/00; G06F 3/01

(52) U.S. Cl. CPC G06T 17/00; G06F 3/012; G06F 3/014

(57) ABSTRACT

Aspects of the present disclosure are directed to native artificial reality system execution of an application using synthetic input from an external device. In traditional use cases, artificial reality system input is provided by input channels native to the system, However, utilizing native input channels can detract from usability in some scenarios, such as during application development and/or testing. Implementations include an interface manager, executing at external device(s), that provides synthetic input to an artificial reality system. The artificial reality system can execute an application using the synthetic input, generate application data via the execution, such as visual information, and stream the application data back to the interface manager at the external device(s). In some implementations, a user defines the synthetic input via interactions with the interface manager, and the interface manager displays, to the user, the application data generated via the synthetic input.

### CROSS-REFERENCE TO RELATED APPLICATIONS

This application claims priority to U.S. Patent Provisional Application No. 63/556,129, titled “Native Artificial Reality System Execution Using Synthetic Input,” filed on Feb. 21, 2024, which is herein incorporated by reference in its entirety.

### TECHNICAL FIELD

The present disclosure is directed to native artificial reality system execution using synthetic input from an external device.

### BACKGROUND

Artificial reality systems have grown in popularity with users, and this growth is expected to accelerate. Artificial reality systems often include a diverse variety of input channels. For example, hand-held controllers and/or body tracking (e.g., hand, arms, head, etc.) can be used to control interactions with a displayed artificial reality environment. Application development for artificial reality systems can sometimes require specific interactions with the system, such as donning a head-mounted display and/or utilizing hand-held controllers to interact with the application under development. In some scenarios, providing input to an artificial reality system via an external or remote device can improve usability.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5A is a conceptual diagram of an external device providing synthetic input to an artificial reality system.

FIG. 5B is a conceptual diagram of an interface manager providing synthetic input to an artificial reality application executing at an artificial reality system.

FIG. 6 is a conceptual diagram of an interface manager and XR environment simulator providing synthetic input to an artificial reality system.

FIG. 7 is a visual display of an interface configured to define synthetic input via user interactions.

FIG. 8 is a flow diagram illustrating a process used in some implementations of the present technology for native artificial reality system execution using synthetic input from an external device.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to native artificial reality system execution of an application using synthetic input from an external device. In traditional use cases, artificial reality system input is provided by input channels native to the system, such as hand-held controllers, a head-mounted display, sensors that track the user's body, peripheral device(s) with which the user interacts, and the like. However, utilizing native input channels can detract from usability in some scenarios, such as during application development and/or testing. Implementations include an interface manager, executing at one or more external devices, that provides synthetic input to an artificial reality system. The artificial reality system can execute an artificial reality application using the synthetic input, generate application data via the execution, such as visual information, and stream the application data back to the interface manager at the external device(s). In some implementations, a user defines the synthetic input via interactions with the interface manager, and the interface manager displays, to the user, the application data generated via the synthetic input.

In some implementations, the interface manager executing at the external device(s) can communicate over a real-time connection with the artificial reality system to support user interactions (e.g., application development, testing, etc.) with the artificial reality application via the external device(s). For example, the artificial reality system can execute the artificial reality application using the synthetic input and generate corresponding visual information (e.g., visual information for a head-mounted display). This visual information can be streamed, via the real-time connection, to the external device(s) and the interface manager, which can display it to the user. By defining synthetic input and receiving application data (e.g., visual information) generated via native artificial reality system execution, the interface manager supports real-time user interactions with the artificial reality application without requiring the user to interact with the native input channels of the artificial reality system.

Examples of synthetic input for an artificial reality application include hand-held controller input (e.g., button presses, joystick input, controller movement, etc.) head-mounted display input (e.g., tracked user movements, etc.), peripheral device input (e.g., trackpad input), user gestures and/or user tracking (e.g., gaze tracking, hand/arm tracking, head tracking, body tracking, etc.), input configured for a virtual object (e.g., x-axis and y-axis values, etc.), and the like. A user can interact with the interface manager executing at the external device(s) to define the synthetic input, such as via a user interface (e.g., virtual controller, etc.), peripheral device, or any other suitable interaction technique. Once defined, the interface manager can transmit the synthetic input to the artificial reality system for application execution.

At the artificial reality system, a mode manager can utilize the synthetic input to execute the artificial reality application. In some implementations, the artificial reality system can operate in standard mode (e.g., utilizing native input channels) or synthetic input mode. In synthetic input mode, the mode manager can override one or more native input channels with the received synthetic input, thus enabling a user interacting with the interface manager/external device(s) to control native execution of the artificial reality application at the artificial reality system. This native execution, at the artificial reality system via the synthetic input, can generate application data such as visual information that represents a three-dimensional environment (e.g., configured for display to the user via a head-mounted display). By streaming the application data to the interface manager at the external device(s) over a real-time connection, the user interacting with the interface manager can both: define synthetic input for the natively executing artificial reality application and view the visual information generated by the natively executing artificial reality application in response to the synthetic input.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

In traditional systems, developing and/or testing artificial realty applications often involves donning and removing a headset of an artificial reality system. Implementations solve this friction point by utilizing an external device that provides a more practical user setting for developing/testing. For example, the synthetic input can simulate the experience of using an artificial reality system without requiring a user to actually don the headset. In addition, implementations utilize native artificial reality system execution rather than execution via an emulator, thus providing developers/testers with (more accurate) native execution feedback, e.g., with the real constraints of the artificial reality device, such as memory usage while executing the XR control systems, power and heat constraints, processor capabilities and configurations, and the like.

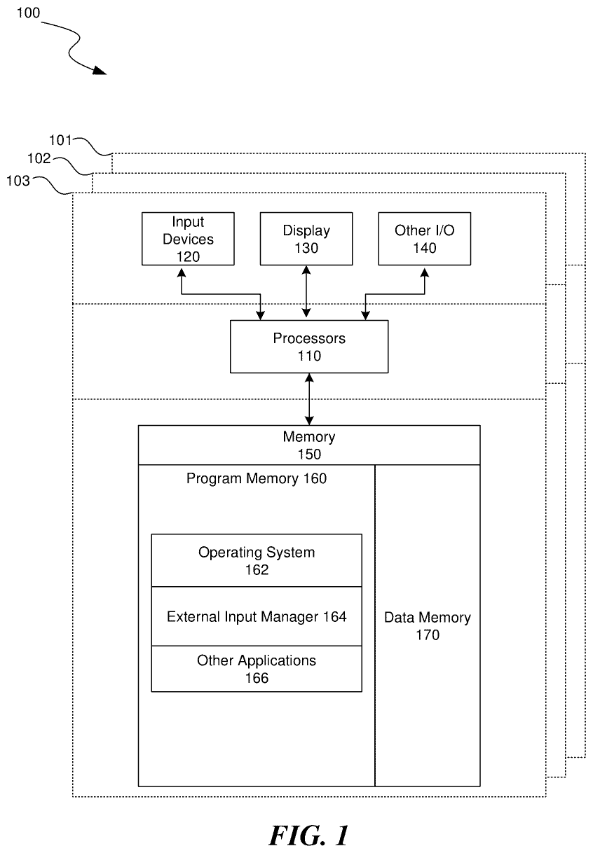

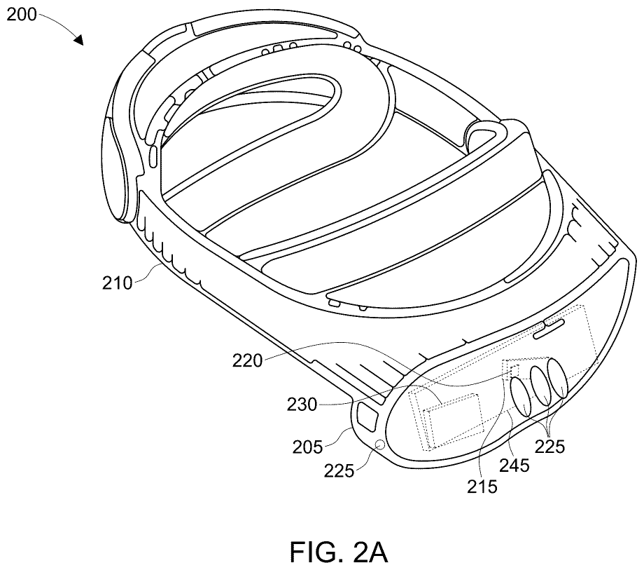

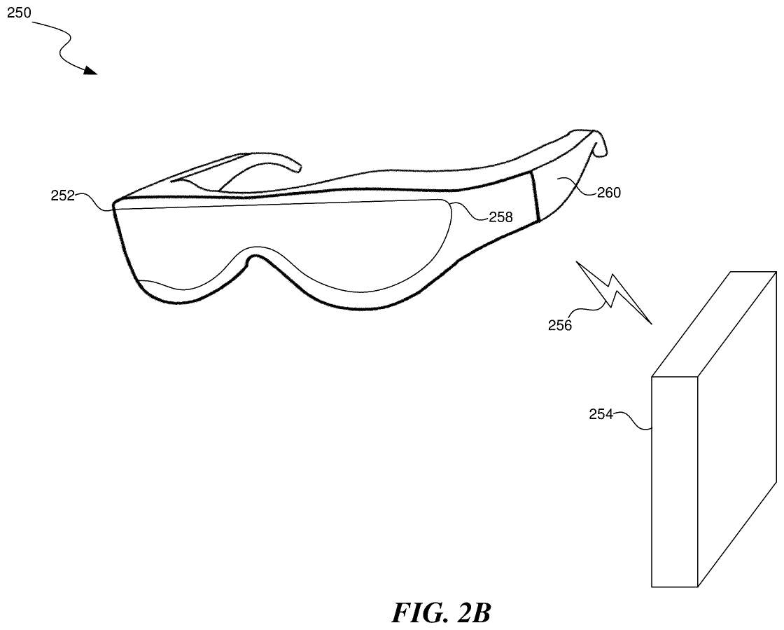

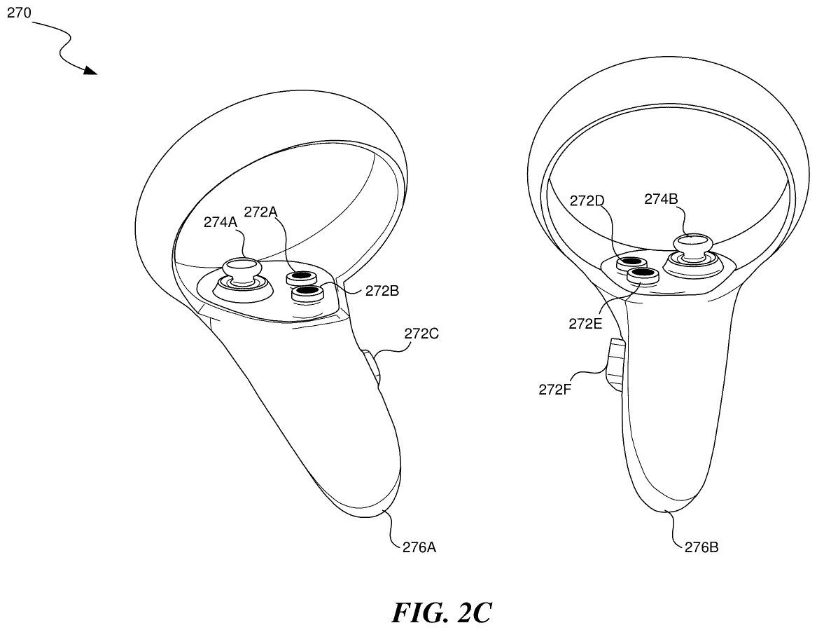

Several implementations are discussed below in more detail in reference to the figures. FIG. 1 is a block diagram illustrating an overview of devices on which some implementations of the disclosed technology can operate. The devices can comprise hardware components of a computing system 100 that perform native artificial reality system execution using synthetic input from an external device. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, input manager 164, and other application programs 166. Memory 150 can also include data memory 170 that can include, e.g., synthetic input data, virtual object data, visual information, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an artificial reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

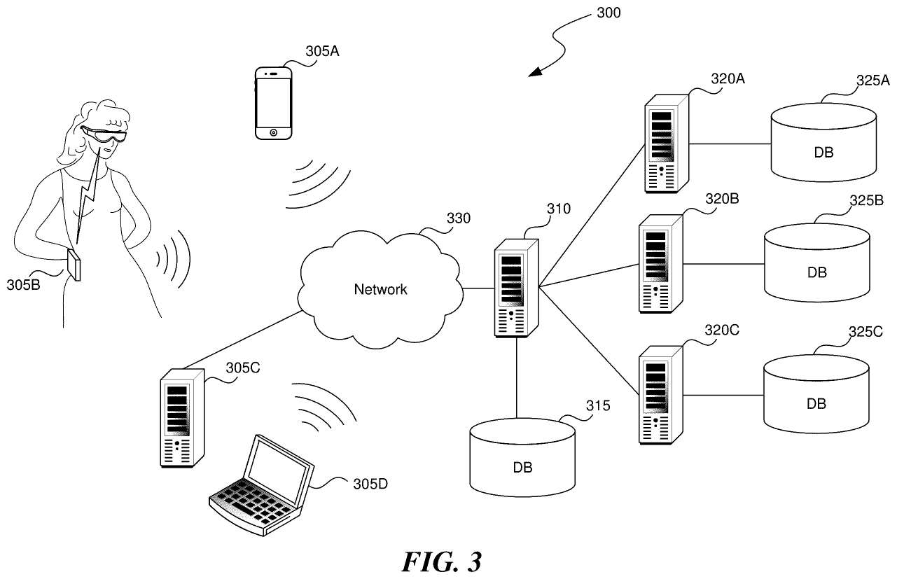

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

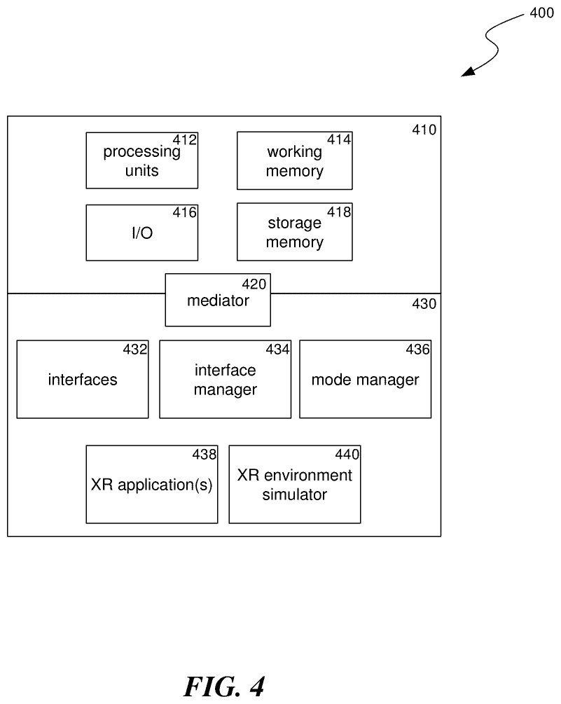

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for native artificial reality system execution using synthetic input from an external device. Specialized components 430 can include interface manager 434, mode manager 436, XR application(s) 438, XR environment simulator 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

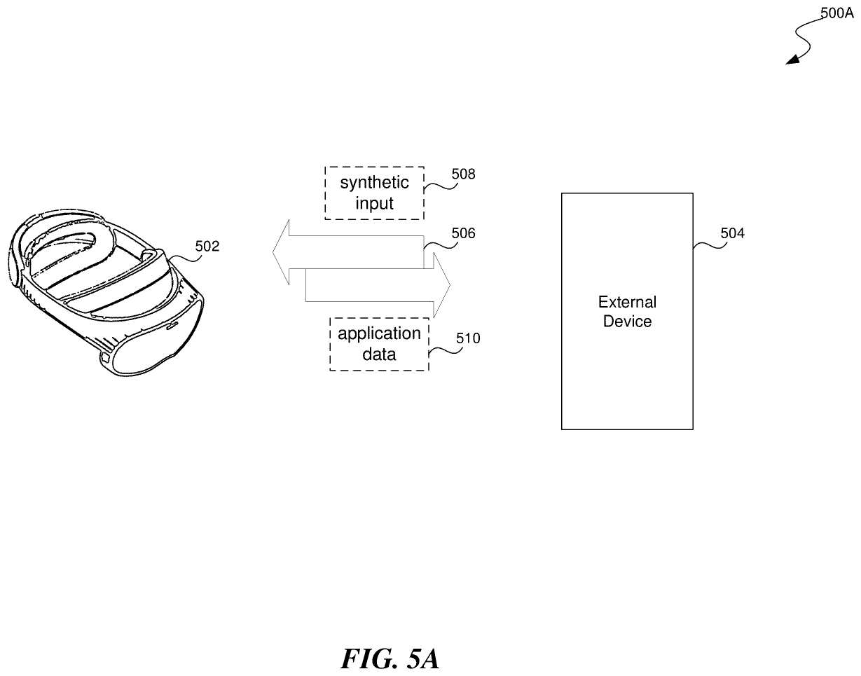

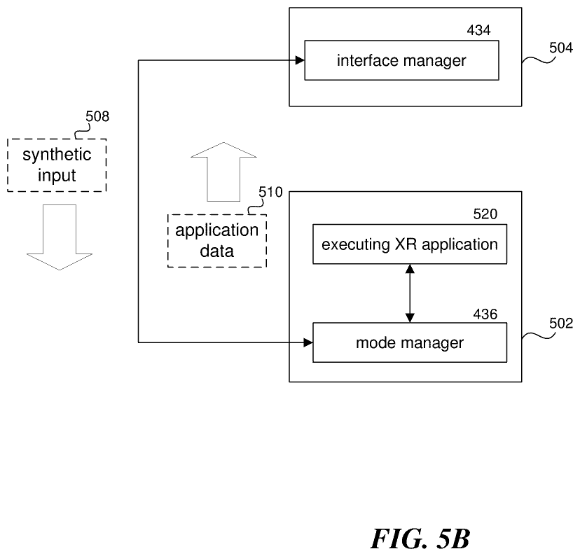

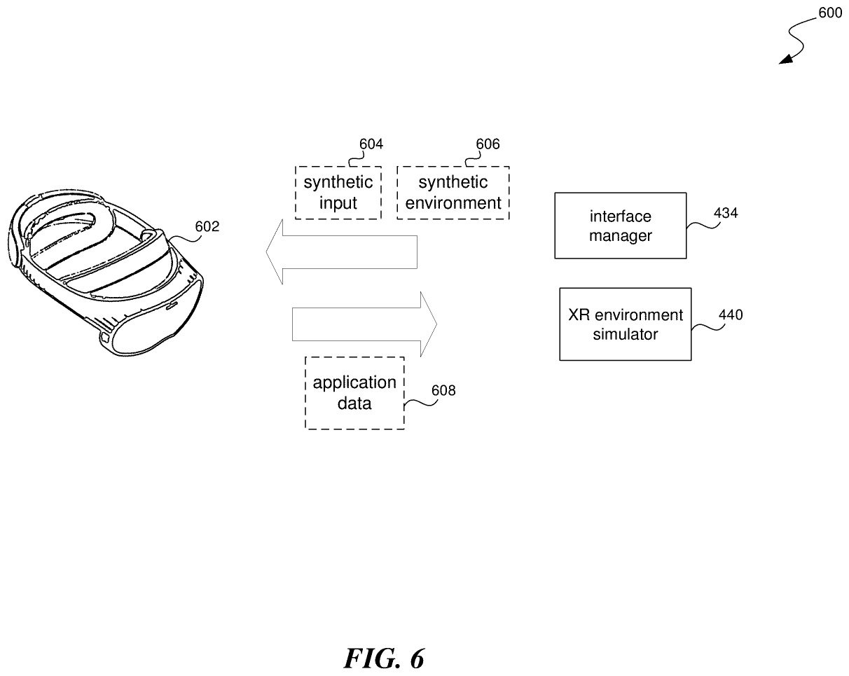

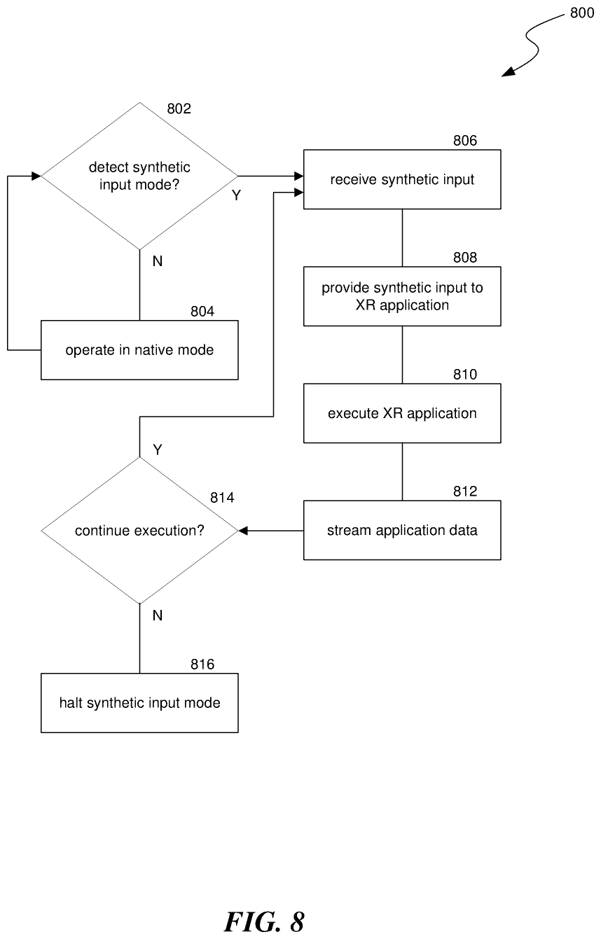

Interface manager 434 can define synthetic input and display visual information to a user of an external device. For example, interface manager 434 can define synthetic input for an XR application via interactions with the user and transmit the synthetic input to a module of a XR system, such as mode manager 436. Mode manager 436 can manage native execution of the XR application at the XR system in response to the synthetic input, and stream back to interface manager 434 application data generated by the execution, such as visual information. In some implementations, interface manager 434 defines synthetic input for an XR application via interactions with the user. Additional details on interface manager 434 are provided below in relation to FIGS. 5B, 6, and blocks 806 and 812 of FIG. 8.

Mode manager 436 can manage native XR application execution at an XR system. For example, the XR system can operate in native mode or synthetic input mode. In native mode, mode manager 436 can provide native input to an executing XR application via input channels native to the XR system (e.g., sensor input, hand-held controller input, HMD input, etc.). In synthetic input node, mode manager 436 can receive synthetic input from interface manager 434 (e.g., executing at one or more external devices) and provide the synthetic input to the executing XR application. Application data responsive to the synthetic input can be generated by executing the XR application, and mode manager 436 can stream this application data to interface manager 434. In some implementations, interface manager 434 and mode manager 436 communicate over a low-latency and/or real-time communication channel. Additional details on mode manager 436 are provided below in relation to FIG. 5B and blocks 802-816 of FIG. 8.

XR application(s) 438 can be XR applications configured for execution at an XR system. For example, executing XR application(s) 438 can generate 2D or 3D displays, support user and virtual object interactions, generate audio and/or visual information, and the like. Examples for XR application(s) include panel applications (e.g., 2D applications), applications that generate a 3D environment, an XR system shell, audio applications (e.g., music and/or video players), gaming applications, and the like. Additional details on XR application(s) 438 are provided below in relation to blocks 808 and 810 of FIG. 8.

XR environment simulator 440 can be a simulator that generates synthetic environment input for an XR system. For example, XR environment simulator 440 may execute at computing device(s) that are not capable of XR display (e.g., in a server, laptop, edge device, cloud device, etc.). In some implementations, XR environment simulator 440 can simulate an environment that surrounds an XR system, thus supporting different environmental use cases in which an XR application may be executing. For example, synthetic input provided to an XR system can include input from interface manager 434 (e.g., simulated hand-held controller input, user tracking, etc.) and a simulated surrounding environment for the XR system (e.g., simulated objects proximate to the system, simulated lighting conditions, simulated indoor/outdoor conditions, etc.). An XR application executing at the XR system can execute responsively to both the simulated input from interface manager 434 and the simulated environment from XR environment simulator 440. In some implementations, interface manager 434 and XR environment simulator 440 execute at a same computing device. In some implementations, interface manager 434 and XR environment simulator 440 execute at different computing devices. Additional details on XR environment simulator 440 are provided below in relation to blocks 808 and 810 of FIG. 8.

FIG. 5A is a conceptual diagram of an external device providing synthetic input to an artificial reality system. Diagram 500 depicts XR system 502, external device 504, communication channel 506, synthetic input 508, and application data 510. XR system 502 can be any suitable XR system, such as those depicted in FIGS. 2A, 2B, 2C, 3, and/or 4. External device 504 can be one or more computing devices external from XR system 502, such as a desktop, laptop, tablet, smartphone, wearable device, cloud computing device, edge computing device, smart home device, remote computing device, any combination thereof, or any other suitable computing device.

Communication channel 506 can be established between external device 504 and XR system 502, such as a real-time and/or low-latency communication channel. In some examples, external device 504 can be configured to establish communication channel 506 via any suitable network protocol. For example, an application executing at external device 504 can be configured to control XR system 502, such as boot up the XR system, alter its operating mode (e.g., switch from native mode to synthetic input mode), etc., and establish communication channel 506. In other examples, XR system 502 or any other suitable device(s) can establish communication channel 506. Communication channel 506 can utilize any suitable network protocol that achieves low-latency and/or real-time communication (e.g., Transmission Control Protocol/Internet Protocol (TCP/IP), WebRTC, Real-time Transport Protocol (RTP), etc.).

In some implementations, external device 504 connects to a sandboxed environment of XR system 502. For example, the sandboxed environment can include specific operating conditions, XR applications, permissions, and the like. In some implementations, the sandboxed environment operates in synthetic input mode by default. For example, a given XR application can execute within the sandboxed environment, external device 504 can provide synthetic input to the given XR application (e.g., via communication channel 506) and the given XR application can stream, back to external device 504 via communication channel 506, application data 510 responsive to the synthetic input. In this example, the given XR application, while executing in the sandboxed environment, can have restrictions related to its execution at XR system 502, such as restrictions to resources (e.g., processing resources, storage resources, etc.), permission restrictions for interacting with other software, and any other security and/or processing restrictions suitable to sandboxed environments.

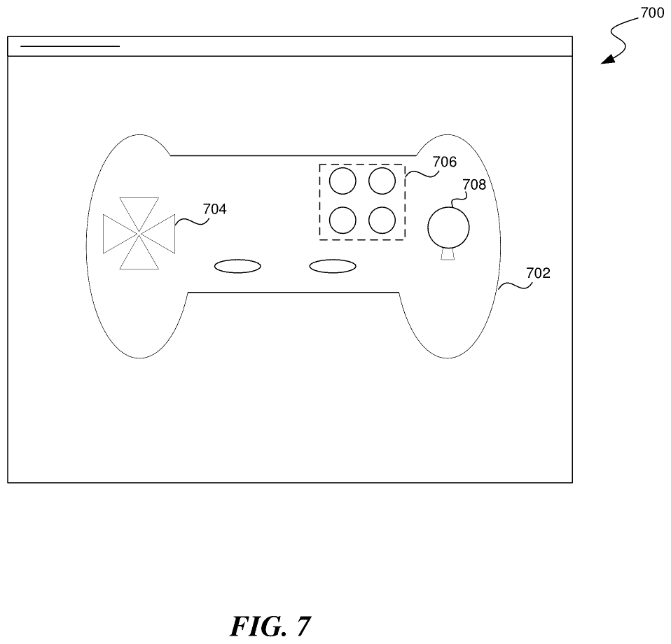

A user can interact with an application executing at external device 504 (e.g., a component of interface manager 434 of FIG. 4) to define synthetic input 508. For example, the user can define different types of synthetic input for an XR application that executes at XR system 502, such as hand-held controller input (e.g., button presses, joystick input, controller movement, etc.) head-mounted display input (e.g., tracked user movements, etc.), peripheral device input (e.g., trackpad input), user gestures and/or user tracking (e.g., gaze tracking, hand/arm tracking, head tracking, body tracking, etc.), input configured for a virtual object (e.g., x-axis and y-axis values, etc.), sensor input, and the like. Descriptions with reference to FIG. 7 further describe examples of a user interacting with an application executing at external device 504 to define synthetic input.

In some implementations, external device 504 can transmit synthetic input 508 to XR system 502 over communication channel 506, XR system 502 can execute an XR application responsive to synthetic input 508 to generate application data 510, and application data 510 can be streamed from XR system 502 to external device 504 over communication channel 506. FIG. 5B is a conceptual diagram of an interface manager providing synthetic input to an artificial reality application executing at an artificial reality system. Diagram 520 depicts XR system 502, external device 504, executing XR application 520, as well as interface manager 434 and mode manager 436 of FIG. 4.

As illustrated, interface manager 434 of FIG. 4 can execute at external device 504 and mode manager 436 of FIG. 4 can execute at XR system 502. Interface manager 434 can define synthetic input 508 and transmit the synthetic input to mode manager 436. Mode manager 435 can receive synthetic input 508 and provide the synthetic input to executing XR application 520 to generate application data 510. For example, mode manager 435 can override one or more native input channels for XR system 502 while the XR system operates in synthetic input mode, such as overriding sensor signals (e.g., proximity sensors), HMD input (e.g., head orientation), user head, gaze, face, and/or body tracking, hand-held controller input, XR system guardian tracking (e.g., safety boundary for using XR system 502), and the like. In some implementations, executing XR application 520 executes in a sandboxed environment at XR system 502 that comprises resources restrictions and/or access restrictions.

In an example, synthetic input 508 can be X and Y coordinates for a cursor with respect to a 2D panel, and executing XR application 520 can drive a cursor on a 2D panel responsive to the provided input. In this example, application data 510 can include visual information of the 2D panel with the cursor movement(s), such as streaming video. In another example, synthetic input 508 can be HMD orientation input and/or gaze tracking input, and executing XR application 520 can change a visual perspective of an immersive environment in response to the provided input. In this example, application data 510 can include visual information of the immersive environment, such as streaming video. In some implementations, this visual information can be simplified from a 3D representation to a 2D representation for display to a user via external device 504. In some implementations, this visual information can be processed to generate 3D video.

In another example, synthetic input 508 can be a button press, user gesture, or any other suitable input representative of user selection, and executing XR application 520 can: a) select a targeted element (e.g., virtual button on a 2D panel) responsive to the provided input; and b) perform any suitable XR application functionality in response to the selection (e.g., open a new 2D panel, alter the display of the existing 2D panel, play a video and/or audio, trigger gaming functionality, etc.). In this example, application data 510 can include visual information of executing application 520, such as streaming video.

Once executing, application 520 generates application data 510 and mode manager 436 can stream application data 510 back to interface manager 434, such as streaming video, immersive visual information, generated audio, data that represents haptic feedback for a hand-held controller or peripheral device, or any other suitable XR application data for output to a user. Interface manager 434 can then display and/or output streamed application data 510 (e.g., visual information, audio, etc.) to the user interacting with external device 504. For example, external device 504 can include a display, speakers, and/or a peripheral device for outputting application data 510 to the user.

Returning to FIG. 5A, because communication between XR system 502 and external device 504 occurs over a real-time and/or low-latency communication channel (e.g., communication channel 506) the user can provide synthetic input and view XR application functionality responsive to this synthetic input in real time. This real-time XR application view from external device 504 can support use cases such as XR application development, testing, and other suitable uses.

In some implementations, external device 504 and a user interacting with the external device can be co-located (e.g., physically near) XR system 502, such as in the same room/building, or remote from XR system 502. For example, XR system 502 can be part of a pool of XR systems available to XR application developers so that these developers can conduct native testing on XR applications under development. This pool of XR systems can be physically located remote from external device 504, however the user can utilize synthetic input to execute native XR application functionality via the pool of XR systems. In some examples, communication channel 506 can be a real-time and/or low-latency communication channel over a variety of network connections (e.g., wired networks, wireless networks, Wi-Fi networks, cellular networks, etc.).

In some implementations, the user can interact with a hand-held controller of XR system 502 along with external device 504 to provide input to the executing XR application. For example, the hand-held controller can provide input to the executing XR application, and the application data 510 generated responsive to this input can be streamed to external device 504 for display to the user. In some implementations, when utilizing the hand-held controller, the relative positioning of the controller can be reoriented. For example, rather than a relative position from an HMD of XR system 502, the relative position can be reoriented to the location of a display of external device 504 and/or relative to any other suitable reference point (e.g., component of external device 504, the user, etc.).

In some implementations, an XR system can be provided synthetic input that includes a synthetic surrounding environment. For example, the synthetic surrounding environment can provide a simulated environmental context for an XR application executing at the XR system. FIG. 6 is a conceptual diagram of an interface manager and XR environment simulator providing synthetic input to an artificial reality system. Diagram 600 depicts XR system 602, synthetic input 604, synthetic environment 606, application data 608, as well as interface manager 434 and XR environment simulator 440 of FIG. 4.

As illustrated in FIGS. 5A and 5B, interface manager 434 can provide synthetic input 604 for an XR application executing at XR system 602. In addition, XR environment simulator 440 can transmit synthetic environment 606 to XR system 602. Synthetic environment 606 can comprise synthetic sensor signals and/or synthetic environment components that surround XR system 602, such as proximity sensor signals, simulated objects proximate to XR system 602, simulated lighting conditions, simulated video feed(s), simulated face tracking (e.g., based on a model of a human face exhibiting predefined expressions), and the like. In some implementations, synthetic environment 606 can comprise environmental surroundings with respect to a spatial location in a large simulated environment. For example, a spatial location in a simulated mall environment may include environmental surroundings such as the interior of a large building (e.g., high ceiling, a floor, walls, etc.) an elevator, one or more storefronts, a piece of artwork, and the like.

Synthetic input 604 and synthetic environment 606 can be provided to the executing XR application, and application data 608 can be generated responsive to synthetic input 604 and synthetic environment 606. For example, application data 608 can include visual information of simulated environment 606, visual information of interactions with objects from simulated environment 606, as the like. Application data 608 can be streamed from XR system 602 to interface manager 434, which can output application data 608 to a user (e.g., display the visual information).

FIG. 7 is a visual display of an interface configured to define synthetic input via user interactions. User interface 700 includes virtual controller 702, virtual direction pad 704, virtual buttons 706, and virtual joystick 708. In some implementations, user interface 700 can be a component of interface manager 434 of FIG. 4 executing at an external device. For example, user interface 700 can be displayed to a user of the external device.

The user can interact with user interface 700 to define synthetic input for an XR application executing at an XR system. Virtual controller 702 can include virtual direction pad 704, virtual buttons 706, and virtual joystick 708. In some implementations, the external device includes (or is in communication with) peripheral devices (e.g., mouse, keyboard, gaming controller, trackpad, touchscreen, etc.) for the user. The user can manipulate these peripheral devices to interact with the components of virtual controller 702 to define synthetic input (e.g., button presses, X and Y coordinates, joystick input, etc.) for XR applications. In some cases, the user input to peripheral devices can be directly mapped to XR system inputs, without providing the virtual controller 702 intermediary. For example, a user can directly move a mouse, which is mapped to moving a ray location in the artificial reality environment, tracked virtual hands movement, or any other suitable XR system inputs. In another example, the external device can comprise a touch screen and/or trackpad, and the user's touch can be directly mapped to a suitable XR system input (e.g., movement of a ray location, tracked virtual hands movement, etc.).

Those skilled in the art will appreciate that the components illustrated in FIGS. 1-7 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 8 is a flow diagram illustrating a process used in some implementations of the present technology for native artificial reality system execution using synthetic input from an external device. Process 800 can execute at an XR system. In some implementations, process 800 is triggered when the XR system is booted or enters an operating mode for executing XR applications.

At block 802, process 800 can detect whether the XR system is in synthetic input mode. For example, the XR system can operate in native mode, where native input channels are active, or synthetic input mode, where one or more native input channels are overridden by synthetic input provided to the XR system. The operating mode can be indicated by a flag value (e.g., 0 or 1) that is set and/or detected by a system shell. In some implementations, operating in synthetic input mode occurs while a system shell and/or XR application executes (or is launched) in a sandboxed environment. In some implementations, synthetic input mode can be triggered in response to a real-time communication channel with an external device configured to provide synthetic input, detection of a software component at the external device configured to provide synthetic input, a user of the XR system manually setting the system to synthetic input mode, and the like. When the XR system is in synthetic input mode, process 800 can progress to block 806. When the XR system is not in synthetic input mode, process 800 can progress to block 804.

At block 804, process 800 can execute in native mode. For example, in native mode the XR system can receive user input via native input channel(s) and execute XR applications responsive to this input. Native input channels can include one or more of HMD input, hand-held controller input, sensed movement input from a user of the XR system, eye/gaze tracking input, and the like. The XR system can continue operating in native mode until it is detected that the XR system is put into synthetic input mode at block 802.

At block 806, process 800 can receive synthetic input. For example, the synthetic input can be received at the XR system from an external device in communication with the XR system over a real-time and/or low-latency communication channel. In some implementations, the external device can be configured to establish the communication channel via any suitable network protocol. For example, an application executing at the external device can be configured to control the XR system, such as boot up the XR system, alter its operating mode (e.g., switch from native mode to synthetic input mode), and establish the communication channel. In other examples, the XR system or any other suitable device(s) can establish the communication channel. The communication channel can utilize any suitable network protocol that achieves low-latency and/or real-time communication (e.g., Transmission Control Protocol/Internet Protocol (TCP/IP), WebRTC, Real-time Transport Protocol (RTP), etc.).

Examples of synthetic input include hand-held controller input (e.g., button presses, joystick input, controller movement/position, etc.) head-mounted display input (e.g., tracked user movements, etc.), peripheral device input (e.g., trackpad input), user gestures and/or user tracking (e.g., gaze tracking, hand/arm tracking, head tracking, body tracking, etc.), input configured for a virtual object (e.g., X and Y coordinate values, etc.), and the like. For example, the synthetic input can be synthetic hand-held controller input, and the synthetic hand-held controller input can be simulated button press input or simulated movement input. The simulated button press input can simulate one or more button presses from a hand-held controller of the XR system and the simulated movement input can simulate movement of the hand-held controller of the XR system, the simulated movement being 3DoF movement or 6DoF movement. In another example, the synthetic input can be synthetic head-mounted display input, and the synthetic head-mounted display input can be simulated movement of a head-mounted display of the XR system, the simulated movement being 3DoF movement or 6DoF movement. In another example, the synthetic input can be synthetic input configured for a virtual object, and the synthetic input configured for a virtual object can be location coordinates with respect to the virtual object and/or selection input with respect to the virtual object.

In some implementations, a user can define the synthetic input via interactions with a user interface. For example, a user interface displayed to user (e.g., two-dimensional panel, etc.) can include interactive components, such as a displayed hand-held controller with interactive button(s) and/or joystick(s), and the user can define the synthetic input via interactions with these components. In another example, the user can interact with peripheral device(s) (e.g., a mouse, trackpad, touchscreen, controller device unaffiliated with the XR system, etc.) to define the synthetic input.

At block 808, process 800 can provide the synthetic input to an executing XR application. In some implementations, XR system input channel(s) that provide the XR application input in native mode can be overridden by the synthetic input received at the XR system from the external device. For example, one or more native input channels of the XR system, such as overriding sensor signals (e.g., proximity sensors), HMD input (e.g., head orientation), user head, gaze, face, and/or body tracking, hand-held controller input, XR system guardian tracking (e.g., safety boundary for using XR system 502), and the like, can be overridden by the synthetic input while the XR system operates in synthetic input mode.

At block 810, process 800 can execute the XR application. For example, the XR system can execute the XR application responsive to the synthetic input and generate application data via the execution. The generated application data can include visual information (e.g., the display state of a 2D application, such as a panel app, or 3D environment), audio information, data indicative of haptic feedback (e.g., hand-held controller haptic feedback), and any other suitable application data for output to a user.

At block 812, process 800 can stream the application data to the external device. For example, the XR system can stream the generated application data to the external device over the real-time and/or low-latency communication channel. In some implementations, the streamed application data can comprise video data, audio data, data indicative of XR system output (e.g., haptic feedback signals), and any other suitable data. The external device can output the streamed application data to the user that provided the synthetic input, such as output audio, video, and/or peripheral device feedback (e.g., haptic feedback). The user can view the streamed application data in real-time relative to providing the synthetic input, thus permitting the user to develop and/or test the XR application executing at the XR system. In some implementations, the external device and/or user can be remote from the XR system. In some implementations, the external device, user, and XR system can be co-located.

At block 814, process 800 can determine whether to continue execution of the XR application in synthetic input mode. For example, one or more conditions can terminate execution of the XR application and/or switch the operating mode of the XR system from synthetic input mode to native mode. In some implementations, user interactions with native XR system elements (e.g., HMD and/or hand-held controller, such as donning the HMD and/or picking up the hand-held controller) can trigger a switch from synthetic input mode to native input mode. In another example, the synthetic input may terminate execution of the XR application, such as close XR application and/or power off the XR system.

When it is determined to continue the execution of the XR application in synthetic input mode, process 800 can loop back to block 806, where additional synthetic input is received. For example, process 800 can loop between blocks 806, 808, 810, 812, and 814 until it is determined to end the execution of the XR application in synthetic mode. When it is determined to end the execution of the XR application in synthetic mode, process 800 can progress to block 816, where execution of the XR application and/or synthetic input mode at the XR system can be halted.

At block 814, process 800 can pause and/or terminate synthetic input mode. For example, synthetic input mode can be temporarily paused (e.g., while the user interacts with the XR system in native mode, etc.) or terminated. In the example where the synthetic input mode is paused, synthetic input mode can be resumed based on detected user interactions. For example, synthetic input mode can be paused while the user interacts with native components of the XR system (e.g., native hand-held controller(s), native HMD, etc.), such as when the user and XR system are co-located. The user can then cease interactions with the native components of the XR system and resume interactions with the external device. Upon detection that the user has resumed interactions with the external device, the XR system can resume the paused synthetic input mode (e.g., resume synthetic input mode via blocks 806, 808, 810, 812, and 814).

In some implementations, while in synthetic input mode the native input channels overridden by synthetic input from the external device can be dynamic. For example, the XR system may be co-located with the external device/user, and while in synthetic input mode the user may pick up a hand-held controller of the XR system. The input from the hand-held controller can be detected, and one or more native input channels from the hand-held controller can retake priority from the synthetic input such that these one or more channels are no longer overridden. For example, the hand-held controller can provide 3DoF or 6DoF tracking input while it is held by the user.

In some implementations, the XR application executes in a sandboxed environment at the XR system. For example, the external device can be connected, via the real-time communication channel, to the sandboxed environment of the XR system. In some implementations, the sandboxed environment at the XR system can be restricted in relation to native execution at the XR system (e.g., a non-sandboxed environment). Example sandboxed environment restrictions can be resource restrictions (e.g., limited processing resources, storage resources, etc.) and/or access restrictions (e.g., limited software interactions, storage access, etc.).

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for native artificial reality (XR) system execution of an XR application using synthetic input from an external device, the method comprising:
receiving, at the XR system over a real-time communication channel established between the XR system and the external device, synthetic input for an XR application executing at the XR system;
executing, at the XR system, the XR application in response to the synthetic input, wherein the executing includes:
overriding native XR system input for the XR application using the synthetic input; and
generating visual information for the XR system based on the synthetic input; and
streaming, from the XR system to the external device, the generated visual information, wherein the external device displays the streamed visual information.

2. The method of claim 1, wherein the synthetic input comprises one or more of: synthetic hand-held controller input that simulates XR system hand-held controller input, synthetic head-mounted display input that simulates XR system head-mounted display input, synthetic user gestures and/or user tracking input, synthetic input configured for a virtual object, or any combination thereof.

3. The method of claim 2, wherein the synthetic input comprises synthetic hand-held controller input, and wherein the synthetic hand-held controller input comprises simulated button press input or simulated movement input.

4. The method of claim 3 wherein the simulated button press input simulates one or more button presses from a hand-held controller of the XR system, and the simulated movement input simulates movement of the hand-held controller of the XR system, the simulated movement comprising 3DoF movement or 6DoF movement.

5. The method of claim 2, wherein the synthetic input comprises synthetic head-mounted display input, and wherein the synthetic head-mounted display input comprises simulated movement of a head-mounted display of the XR system, the simulated movement comprising 3DoF movement or 6DoF movement.

6. The method of claim 2, wherein the synthetic input comprises synthetic input configured for a virtual object, and wherein the synthetic input configured for a virtual object comprises location coordinates with respect to the virtual object.

7. The method of claim 1, wherein the receiving of the synthetic input at the XR system, the executing the XR application, and the streaming of the generated visual information from the XR system to the external device occurs in real-time.

8. The method of claim 1, wherein the synthetic input is received at the external device from a user via interactions with a user interface displayed by the external device and/or a display associated with the external device.

9. The method of claim 1, wherein the XR system is at a location remote from the external device and the user of the external device.

10. The method of claim 1, wherein,
the XR application executes in a sandboxed environment at the XR system,
the external device is connected, via the real-time communication channel, to the sandboxed environment of the XR system, and
the sandboxed environment at the XR system comprises resource restrictions and/or access restrictions.

11. An artificial reality (XR) system for native execution of an XR application using synthetic input from an external device, the XR system comprising:
one or more processors; and
one or more memories storing instructions that, when executed by the one or more processors, cause the XR system to:
receive, over a real-time communication channel established between the XR system and the external device, synthetic input for an XR application executing at the XR system;
execute, at the XR system, the XR application in response to the synthetic input, wherein the executing includes:
overriding native XR system input for the XR application using the synthetic input; and
generating visual information for the XR system based on the synthetic input; and
stream, from the XR system to the external device, the generated visual information, wherein the external device displays the streamed visual information.

12. The XR system of claim 11, wherein the synthetic input comprises one or more of: synthetic hand-held controller input that simulates XR system hand-held controller input, synthetic head-mounted display input that simulates XR system head-mounted display input, synthetic user gestures and/or user tracking input, synthetic input configured for a virtual object, or any combination thereof.

13. The XR system of claim 12, wherein the synthetic input comprises synthetic hand-held controller input, and wherein the synthetic hand-held controller input comprises simulated button press input or simulated movement input.

14. The XR system of claim 13 wherein the simulated button press input simulates one or more button presses from a hand-held controller of the XR system, and the simulated movement input simulates movement of the hand-held controller of the XR system, the simulated movement comprising 3DoF movement or 6DoF movement.

15. The XR system of claim 12, wherein the synthetic input comprises synthetic head-mounted display input, and wherein the synthetic head-mounted display input comprises simulated movement of a head-mounted display of the XR system, the simulated movement comprising 3DoF movement or 6DoF movement.

16. The XR system of claim 12, wherein the synthetic input comprises synthetic input configured for a virtual object, and wherein the synthetic input configured for a virtual object comprises location coordinates with respect to the virtual object.

17. The XR system of claim 11, wherein the receiving of the synthetic input at the XR system, the executing the XR application, and the streaming of the generated visual information from the XR system to the external device occurs in real-time.

18. The XR system of claim 11, wherein the synthetic input is received at the external device from a user via interactions with a user interface displayed by the external device and/or a display associated with the external device.

19. The XR system of claim 11, wherein the XR system is at a location remote from the external device and the user of the external device.

20. A computer-readable storage medium storing instructions for native artificial reality (XR) system execution of an XR application using synthetic input from an external device, the instructions, when executed by the XR system, cause the XR system to:
receive, over a real-time communication channel established between the XR system and the external device, synthetic input for an XR application executing at the XR system;
execute, at the XR system, the XR application in response to the synthetic input, wherein the executing includes:
overriding native XR system input for the XR application using the synthetic input; and
generating visual information for the XR system based on the synthetic input; and
stream, from the XR system to the external device, the generated visual information, wherein the external device displays the streamed visual information.
